(19) United States
(12) Patent Application Publication
(10) Pub. No.: US 2021/0132265 A1
(43) Pub. Date: May 6, 2021

(54) LENS DEVICE, DISPLAY DEVICE AND CONTROL METHOD

(71) Applicants: Beijing BOE Display Technology Co., Ltd., Beijing (CN); BOE Technology Group Co., Ltd., Beijing (CN)

(72) Inventors: Shumeng Sun, Beijing (CN); Minghui Zhang, Beijing (CN); Inho Park, Beijing (CN); Xiaopeng Cui, Beijing (CN)

(73) Assignees: Beijing BOE Display Technology Co., Ltd.; BOE Technology Group Co., Ltd.

(21) Appl. No.: 16/921,080

(22) Filed: Jul. 6, 2020

(30) Foreign Application Priority Data
Oct. 31, 2019 (CN) 201911053242.6

(51) Int. Cl. G02B 3/14; G02B 30/10

(52) U.S. Cl. CPC G02B 3/14; G02B 30/10

(57) ABSTRACT

Provided is a lens device, including a plurality of lens units arranged in an array, wherein the lens unit includes an accommodating cavity, a lens, a magnetic body, and a magnetic field generating member; the lens and the magnetic body are located inside the accommodating cavity, the magnetic field generating member is configured to provide a magnetic field, and the magnetic body is configured to move the lens in a direction perpendicular to an arrangement plane of the plurality of lens units under an action of the magnetic field provided by the magnetic field generating member. A display device and a control method is also provided.

The present application claims priority to Chinese Patent Application No. 201911053242.6, filed on Oct. 31, 2019 and entitled “LENS MODULE, DISPLAY DEVICE AND DISPLAY METHOD”, which is incorporated herein by reference in its entirety.

### TECHNICAL FIELD

The present disclosure relates to the field of display technologies, and particularly, to a lens device, a display device and a display method.

### BACKGROUND

Currently, 3D display methods mainly involve a stereoscopic display method based on binocular parallax. In this method, different images are separately sent to left eye and right eye of a person through lenses. Different viewpoints are then observed by the left and right eye, and thus when perceiving the images, the human brain will acquire a three-dimensional stereoscopic image. Such 3D display method requires the use of external equipment such as a helmet or glasses, and may easily cause tension in head and a sense of vertigo.

### SUMMARY

The embodiments of the present disclosure provide a lens device, a display device and a control method.

In one aspect, the embodiment of the present disclosure provides a lens device, including a plurality of lens units arranged in an array, wherein the lens unit includes an accommodating cavity, a lens, a magnetic body, and a magnetic field generating member; the lens and the magnetic body are located inside the accommodating cavity, the magnetic field generating member is configured to provide a magnetic field, and the magnetic body is configured to move the lens in a direction perpendicular to an arrangement plane of the plurality of lens units under an action of the magnetic field provided by the magnetic field generating member.

Optionally, the magnetic field generating member is a spiral coil, an axis of the spiral coil being perpendicular to the arrangement plane.

Optionally, the spiral coil is a planar spiral coil wound by a transparent wire.

Optionally, the magnetic body is located inside the lens.

Optionally, the magnetic body includes magnetic particles including magnetic powder and a transparent bonding agent.

Optionally, the magnetic body is located between the lens and a side wall of the accommodating cavity.

Optionally, the magnetic body is a transparent magnetic sheet-shaped structure parallel to the arrangement plane.

Optionally, the lens is at least one of the following:

a liquid lens, including a transparent thin film and a transparent liquid inside the transparent thin film; or

a solid lens.

Optionally, the lens unit further includes two opposed substrates and an insulating barrier connected between the two substrates, the substrates and the insulating barrier define the accommodating cavity, and the magnetic field generating member is located on at least one of the substrates.

Optionally, a side wall of the insulating barrier is provided with a magnetic field shielding layer.

Optionally, the lens unit further includes a pair of electrodes located on two sides of a corresponding lens in a direction parallel to the arrangement plane; the lens is a liquid lens including a transparent thin film, and charged particles and a transparent insulating liquid which are located in the transparent thin film; and the charged particles are configured to move under an action of an electric field provided by the pair of electrodes, so as to deform the liquid lens to which they belong.

Optionally, a total volume of the charged particles in the liquid lens accounts for 0.1% to 5% of a volume of the liquid lens.

Optionally, the lens device further includes two opposed substrates and an insulating barrier connected between the two substrates, wherein the substrates and the insulating barrier define a plurality of the accommodating cavities, and the magnetic field generating member is a planar spiral coil located on at least one of the substrates;

the lens unit further includes a pair of electrodes located on a side wall of a corresponding accommodating cavity, and the pair of electrodes are located on two sides of the corresponding lens in a direction parallel to the arrangement plane; and

the lens is a liquid lens including a transparent thin film, and charged particles, magnetic particles and a transparent insulating liquid which are located inside the transparent thin film; the charged particles are configured to move under an action of an electric field provided by the pair of electrodes, so as to deform the liquid lens to which they belong.

Optionally, the lens device further includes a control circuit of the spiral coil and a control circuit of the electrode, wherein the planar spiral coil and the control circuit of the spiral coil are located on one substrate, and the control circuit of the electrode is located on another substrate.

In another aspect, a display device is also provided. The display device includes a display panel and the aforementioned lens device which is located on a light-exiting side of the display panel.

Optionally, the display panel includes a plurality of pixels, and one of the lens units is opposed to one of the pixels in a direction perpendicular to the light-exiting side of the display panel.

In yet another aspect, a control method of a lens device is also provided. The lens device is any one of the aforementioned lens devices, and the method includes:

providing a driving current to the magnetic field generating member of a target lens unit, so that the lens of the target lens unit moves in the direction perpendicular to the arrangement plane, and the target lens unit is any lens unit in the lens device.

Optionally, the method further includes:

providing a driving voltage to the pair of the electrodes of the target lens unit, so as to move the charged particles in the liquid lens of the target lens unit to deform a liquid lens of the target lens unit.

### BRIEF DESCRIPTION OF THE DRAWINGS

In order to describe the technical solutions in the embodiments of the present disclosure more clearly, the following briefly introduces the accompanying drawings required for describing the embodiments. Apparently, the accompanying drawings described below show merely some embodiments of the present disclosure, and a person of ordinary skill in the art may also derive other figures from these accompanying drawings without creative efforts.

FIG. 1 is a top view of a lens device according to an embodiment of the present disclosure;

FIG. 2 is a schematic structural diagram of a lens unit with a lens at a first position according to an embodiment of the present disclosure;

FIG. 3 is a schematic structural diagram of a lens unit with a lens at a second position according to an embodiment of the present disclosure;

FIG. 4 is a schematic structural diagram of lens units with some lenses at a first position and some lenses at a second position according to an embodiment of the present disclosure;

FIG. 5 is a top view of another lens device according to an embodiment of the present disclosure;

FIG. 6 is a schematic structural diagram of a lens unit with a lens in a first state according to an embodiment of the present disclosure;

FIG. 7 is a schematic structural diagram of a lens unit with a lens in a second state according to an embodiment of the present disclosure;

FIG. 8 is a schematic diagram showing the state of a liquid lens in a weak electric field according to an embodiment of the present disclosure;

FIG. 9 is a schematic diagram showing the state of a liquid lens in a strong electric field according to an embodiment of the present disclosure;

FIG. 10 is a schematic structural diagram of another lens device according to an embodiment of the present disclosure;

FIG. 11 is a partial schematic diagram of a control circuit of a electrode according to an embodiment of the present disclosure;

FIG. 12 is a schematic structural diagram of a lens device according to an embodiment of the present disclosure;

FIG. 13 is a diagram showing the relationship between the curvature radius of the lens and the voltage of the electric field in an embodiment; and

FIG. 14 is a flow diagram showing a control method of a lens device according to an embodiment of the present disclosure.

### DETAILED DESCRIPTION

For presenting the objects, technical solutions and advantages of the present disclosure more clearly, the implementations of the present disclosure are further described in detail below in combination with the accompanying drawings.

In the related art, 3D display can be achieved through integral imaging stereoscopic display technology. In this technology, patterns shown on two-dimensional display panel are integrated by a display lens array to reconstruct the image of a three-dimensional object in space. As the integral imaging stereoscopic display technology reconstructs the real image of the object in a three-dimensional space, the audience can watch the image with naked eyes, which will not cause tension in head and fatigue.

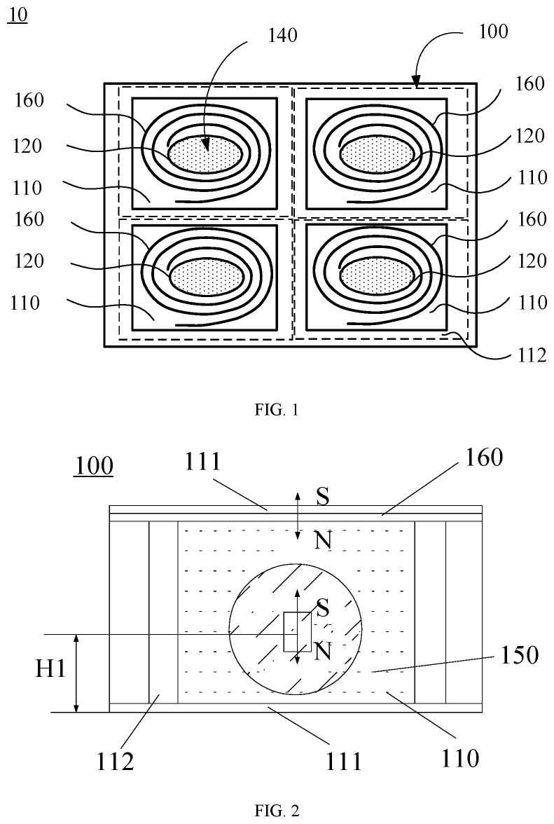

FIG. 1 is a top view of a lens device according to an embodiment of the present disclosure. As shown in FIG. 1, the lens device 10 includes a plurality of lens units 100 arranged in an array. The number of lens units 100 shown in FIG. 1 is only for illustration purpose, and is not intended to limit the embodiments of the present disclosure.

As shown in FIG. 1, each lens unit 100 includes an accommodating cavity 110, a lens 120, a magnetic body 140 and a magnetic field generating member 160. The lens 120 and the magnetic body 140 are located inside the accommodating cavity 110, the magnetic field generating member 160 is configured to provide a magnetic field, and the magnetic body 140 is configured to move the lens 120 in a direction perpendicular to an arrangement plane of the plurality of lens units 100 under the action of the magnetic field provided by the magnetic field generating member 160. Here, the arrangement plane of the plurality of lens units 100 is parallel to the paper plane in FIG. 1, and the magnetic field provided by the magnetic field generating member 160 passes through the arrangement plane.

It should be noted that, in some embodiments, partial of the lens units 100 in the lens device 10 may adopt the structure shown in FIG. 1.

Optionally, the magnetic field generating member 160 is a spiral coil, an axis of the spiral coil being perpendicular to the arrangement plane of the plurality of lens units 100. By adjusting the current parameters of the spiral coil (such as the magnitude and direction of the current), parameters such as the intensity and direction of the magnetic field generated by the spiral coil can be adjusted, so as to change the force exerted by the magnetic field produced by the magnetic field generating member 160 on the magnetic body 140, and to enable the magnetic body 140 to drive the lens 120 to move in a direction perpendicular to the arrangement plane.

Exemplarily, the spiral coil is wound by a wire in the same plane, that is, the spiral coil is a planar spiral coil. The planar spiral coil may be wound by a transparent wire, such as an ITO (Indium Tin Oxides) wire or the like, to reduce the influence of the spiral coil on the light transmittance of the lens unit.

In a possible implementation, the magnetic body 140 is located inside the lens 120. In another possible implementation, the magnetic body is located outside the lens 120, as long as the magnetic body 140 is able to interact with the magnetic field provided by the magnetic field generating member 160 and to drive the corresponding lens 120 to move in a direction perpendicular to the arrangement plane.

Optionally, the lens 120 may be a solid lens. The solid lens may be made of glass or photosensitive resin.

In a possible implementation, as shown in FIG. 1, the magnetic body 140 may be magnetic particles contained inside the solid lens. In this case, the magnetic particles can be mixed in the molten glass or the molten photosensitive resin and are evenly distributed by stirring, and then the glass or photosensitive resin material mixed with the magnetic particles can be cured and molded to obtain a solid lens containing magnetic particles.

Alternatively, the lens 120 may also be a liquid lens which includes a transparent thin film and transparent liquid inside the transparent thin film. The transparent liquid is in a generally spherical shape when being covered by the transparent thin film. In a possible implementation, the magnetic body 140 is magnetic particles located inside the liquid lens. In this case, the liquid lens may include a transparent thin film, and magnetic particles and transparent liquid which are located inside the transparent thin film.

Alternatively, in other embodiments, when the lens 120 is a fixed lens or a liquid lens, the magnetic body 140 may be located outside the lens 120, for example, between the lens 120 and the side wall of the accommodating cavity 120. In this case, the magnetic body may be in a transparent magnetic sheet-shaped structure parallel to the arrangement plane of the plurality of lens units 100.

Exemplarily, the transparent magnetic sheet-shaped structure may be manufactured in the same manner as the solid lens, which is not repeated herein.

Optionally, the magnetic particles 124 include magnetic powder and a transparent bonding agent. Because the magnetic powder is small in volume and is difficult to store, the magnetic powder may be made into the magnetic particles by using a transparent bonding agent, so as to facilitate the storage of the magnetic powder and the addition to the liquid lens. It should be noted that the embodiment of the present disclosure does not limit the type of bonding agent, as long as it can aggregate the magnetic powder to form the magnetic particles.

In the embodiment shown in FIG. 1, the lens unit 110 includes two opposed substrates 111; the accommodating cavity 110 as well as the lens 120 and the magnetic body 140 inside the accommodating cavity 110 are all located between the two substrates 111. The magnetic field generating member 160 is located on one of the substrates 111, for example, on the substrate 111 above the lens 120. It should be noted that, in other embodiments, the magnetic field generating members 160 may also be arranged on the two substrates 111 and are opposed to each other. When the magnetic field generating members 160 are arranged simultaneously on the two substrates 111, the position of the lens 120 can be adjusted by the mutual cooperation of the two magnetic field generating members 160.

Optionally, the magnetic field generating member 160 may be located on the inner surface of the substrate 111 or on the outer surface of the substrate 111. Here, the inner surface refers to the opposing surfaces of the two substrates 111 and the outer surface refers to the opposite surfaces of the two substrates 111.

Here, the substrate 111 can be made of a transparent material, such as glass, plastic, and the like.

The process of adjusting the position of the lens 120 through the magnetic field generating member 160 will be described below with reference to FIGS. 2 and 3. It should be noted that, a liquid lens containing a magnetic body will be described below as an example.

FIG. 2 is a schematic structural diagram of a lens unit with a lens at a first position according to an embodiment of the present disclosure. As shown in FIG. 2, a current is applied to the magnetic field generating member 160 to generate a magnetic field. Through the interaction between the magnetic field provided by the magnetic field generating member 160 and the magnetic particles in the lens 120, the lens 120 stays at the first position, and the distance between the center of the lens 120 and the substrate 111 distal from the magnetic field generating member 160 (that is, the substrate 111 below the lens 120) is H1.

FIG. 3 is a schematic structural diagram of a lens unit with a lens at a second position according to an embodiment of the present disclosure. As shown in FIG. 3, the magnitude of the current in the magnetic field generating member 160 is changed to increase the intensity of the magnetic field provided by the magnetic field generating member 160. Through the interaction between the magnetic field provided by the magnetic field generating member 160 and the magnetic particles in the lens 120, the lens 120 moves upwards to the second position, and the distance between the center of the lens 120 and the substrate 111 distal from the magnetic field generating member 160 (that is, the substrate 111 below the lens 120) is H2, H2 being greater than H1.

When the lens 120 reaches a specified position, the magnitude of the current in the magnetic field generating member 160 can be adjusted to change the attractive force between the magnetic field generating member 160 and the magnetic particles, so that the lens 120 can be suspended at the specified position inside the accommodating cavity 110. For example, the current may be adjusted to result in a balance between the gravity of the lens 120 and other external force thereon, thereby enabling the lens 120 to be suspended at the specified position inside the accommodation cavity 110.

By adjusting the magnitude and/or direction of the current in the magnetic field generating member 160, the magnitude and/or direction of the force between the magnetic field generating member 160 and the magnetic body can be changed, thus the height of the liquid lens in the accommodating cavity 110 can be adjusted. That is, the object distance (i.e., the distance from the center of the lens 120 to the display panel) of the lens unit can be adjusted; and in turn, the imaging height can be fine-tuned. As such, the adjustment to the lens unit 100 will be more flexible, and a better stereoscopic display effect can be obtained.

The principle and process of adjusting the imaging height of the lens unit in the embodiment of the present disclosure are briefly described below.

According to the imaging rule of convex lens, the formula below holds:

$$\frac{1}{u} + \frac{1}{v} = \frac{1}{f} . \qquad ( 1 )$$

In formula (1), u represents object distance, v represents image distance, and f represents focal length of the lens. In the embodiment of the present disclosure, u is the distance from the center of the lens to the display panel, and v is the distance from the center of the lens to the imaging position. From formula (1), the following equation holds:

$$v = \frac{fu}{u - f} . \qquad ( 2 )$$

When the input light is parallel light, v=f. In other words, when the light passing through the lens is parallel light, the image distance is equal to the focal length of the lens, that is, the image will be formed at the focal point. Therefore, the imaging height will meet the equation: h=u+v=u+f. Here, the imaging height refers to the distance between the imaging position and the display panel.

It can be seen that, when the focal length f is constant, the imaging height will change as the change of the object distance u; when the object distance u increases, the imaging height will also increase; and when the object distance u decreases, the imaging height will also decrease.

In the embodiment of the present disclosure, the position of the lens 120 in each lens unit 100 may be different, that is, the distance from the center of the lens 120 to the inner surface of the corresponding substrate 111 may be different, and the object distance u corresponding to the lens 120 is also different.

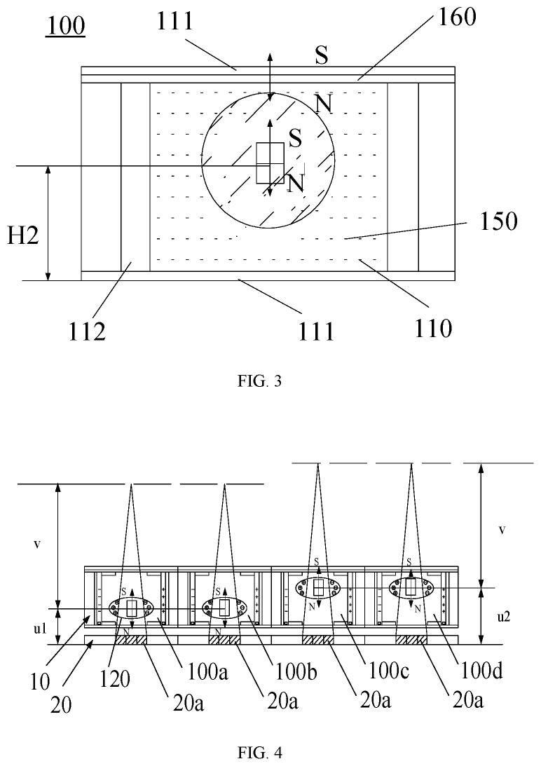

FIG. 4 is a schematic structural diagram of lens units with some lenses at a first position and some lenses at a second position according to an embodiment of the present disclosure. As shown in FIG. 4, the structures of the lenses 120 in the lens units 100a, 100b, 100c, and 100d are the same, and have a same focal length. Therefore, the image distances v in the lens units 100a, 100b, 100c, and 100d are also the same. However, because the object distance u1 of the lens units 100a and 100b (equal to the aforementioned H1) is smaller than the object distance u2 of the lens units 100c and 100d (equal to the aforementioned H2), the imaging height of the lens units 100a and 100b is smaller than that of the lens units 100c and 100d.

In the embodiment of the present disclosure, the lens device includes a plurality of lens units arranged in an array, and each lens unit includes an accommodating cavity, a lens, a magnetic body, and a magnetic field generating member. The lens and the magnetic body are located inside the accommodating cavity, the magnetic field generating member is configured to provide a magnetic field, and the magnetic body is configured to move the lens in a direction perpendicular to an arrangement plane of the plurality of lens units under the action of the magnetic field provided by the magnetic field generating member. Since the arrangement plane is parallel to the light-exiting side of the display panel, by adjusting the magnitude and/or direction of the intensity of the magnetic field generated by the magnetic field generating member, the distance between the center of the corresponding lens and the display panel can be controlled, and the object distance between the center of the lens and the display panel can be adjusted, such that the imaging height can be adjusted and a better stereoscopic display effect can be obtained.

In some embodiments, with reference to FIGS. 2 and 3, the lens unit 100 may further include an insulating barrier 112 connected between the two substrates 111. The two substrates 111 and the insulating barrier 112 define an accommodating cavity 110. In order to enable the lens 120 to move inside the accommodating cavity 110, there is a gap between the lens 120 and at least one of the two substrates 111.

Exemplarily, with reference to FIG. 1 again, the insulating barriers 112 in the respective lens units 100 may be connected as a whole. For example, an insulating material layer may be formed on a substrate 111 first; then the insulating material layer is subjected to a patterning process to form a plurality of grooves, and each accommodating cavity 110 corresponds to a groove, and the portion between the grooves then forms the insulating barrier 112; finally, another substrate 111 is provided on the insulating barrier 112. The two substrates 111 respectively define the top and the bottom surfaces of the accommodating cavity 110, and the insulating barrier 112 defines the side wall of the accommodating cavity 110.

In the embodiment of the present disclosure, the insulating materials for manufacturing the insulating barrier 112 include, but are not limited to, polyimide materials, polyester materials or polyolefin materials.

Optionally, a magnetic field shielding layer may be provided on the insulating barrier 112 to avoid crosstalk between adjacent lens units 100. The magnetic field shielding layer may be made of a material with high magnetic permeability, such as iron or the like.

Exemplarily, the insulating barrier 112 and the spiral coil 160 can be formed on the two substrates 111 respectively. For example, the insulating barrier 112 may formed on the substrate 111 below the lens 120, and the spiral coil 160 may be formed on the substrate 111 above the lens 120.

In some embodiments, the spiral coil 160 can be made by forming a film on the substrate 111 by sputtering first, and then manufacturing the spiral coil 160 through a mask lithography process.

Optionally, a control circuit of the spiral coil 160 may also be provided on the substrate 111 on which the spiral coil 160 is located. In a possible implementation, the control circuit may include a plurality of coil control lines, and each spiral coil 160 is connected to two coil control lines. One coil control line is used as an input line, and the other coil control line is used as an output line.

In a possible implementation, the two coil control wires connected to each spiral coil 160 are different.

In another possible implementation, the control circuit includes a plurality of first coil control lines extending in a first direction and a plurality of second coil control lines extending in a second direction, and the first direction is one of the row direction and column direction of the plurality of lens units, and the second direction is the other direction. The plurality of first coil control lines and the plurality of second coil control lines intersect to define a plurality of display areas, and each of the display areas has a spiral coil 160. A row of spiral coils 160 are connected to one first coil control line, and a column of spiral coils 160 are connected to one second coil control line.

Optionally, each spiral coil 160 may be connected to the first coil control line and/or the second coil control line through a switching device (for example, a thin film transistor); alternatively, each spiral coil 160 may be directly connected to the corresponding first coil control line and the second coil control line respectively, while one of the first coil control line and the second coil control line is connected to an external circuit through a control switch so as to realize separate control of each spiral coil 160.

As mentioned above, the lens 120 may be a liquid lens or a solid lens. By taking the lens 120 being a liquid lens as an example, the embodiment of the present disclosure will be described exemplarily below. When the lens 120 is a liquid lens, in addition to the changeable distance between the lens and the two substrates 111, the shape of the lens 120 may also be changed. In order to implement the deformation of the lens in the accommodating cavity 110, there is also a gap between the lens 120 and the insulating barrier 112.

FIG. 5 is a top view structural diagram of another lens device according to an embodiment of the present disclosure. The difference from the embodiment shown in FIG. 1 is that the lens unit 100 in FIG. 5 further includes a pair of electrodes 130. The pair of electrodes 130 are located on two sides of the corresponding lens 120 in a direction parallel to the arrangement plane of the plurality of lens units 100. It should be noted that, for ease of viewing, the magnetic field generating member 160 and the magnetic body 140 are not shown in FIG. 5.

In the embodiment shown in FIG. 5, the magnetic field generating member 160 does not generate a magnetic field, and the liquid lens is located at the initial position. For example, it may be located at an middle position between the two substrates 111 in a direction perpendicular to the substrates 111, or after the magnetic field is adjusted by the magnetic field generating member 160, the liquid lens is stabilized at an predetermined position between the two substrates 111, and then the liquid lens is deformed through the electrodes 130.

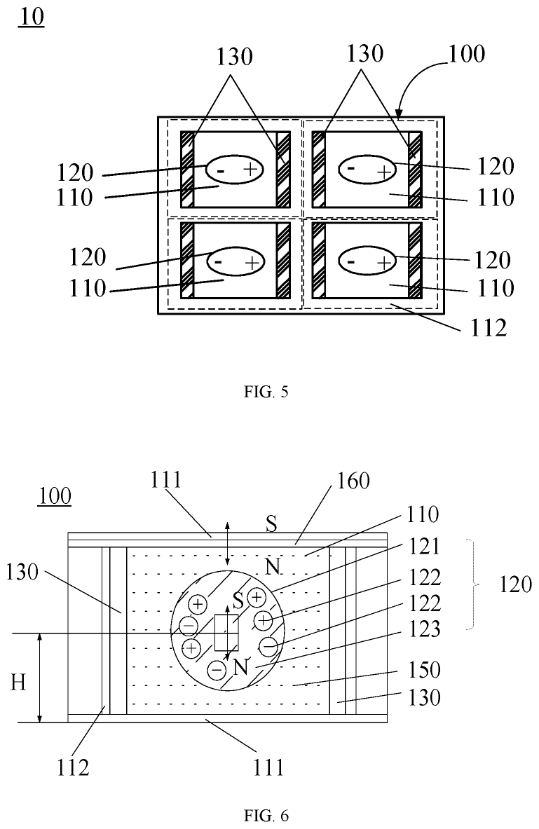

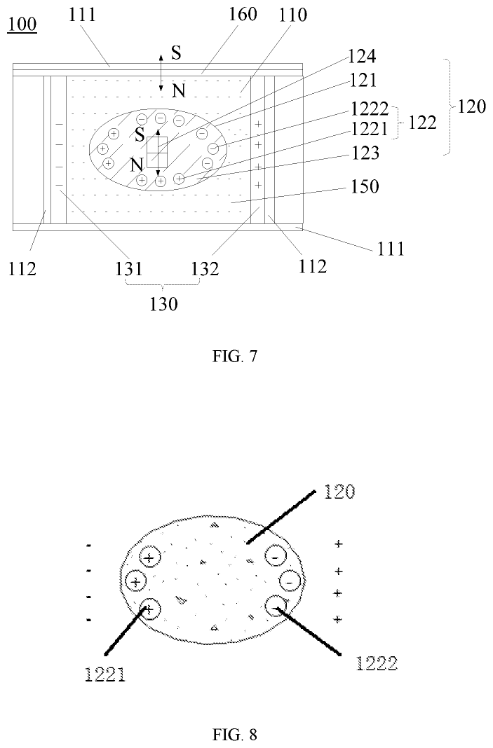

With reference to FIGS. 6 and 7, the process of changing the shape of the liquid lens which stays at a certain position between the two substrates 111 (that is, the distance from the lens to the substrate 111 below the lens being H) from the first state to the second state is described in detail below.

FIG. 6 is a schematic structural diagram of a lens unit with a lens in the first state according to an embodiment of the present disclosure. As shown in FIG. 6, the liquid lens includes a transparent thin film 121, and charged particles 122 and transparent insulating liquid 123 which are located inside the transparent thin film 121; and the charged particles 122 are configured to move under the action of the electric field provided by a pair of electrodes 130, so as to deform the liquid lens.

In the first state shown in FIG. 6, the pair of electrodes 130 does not provide an electric field, and the liquid lens is not deformed and is substantially spherical.

FIG. 7 is a schematic structural diagram of a lens unit with a lens in a second state according to an embodiment of the present disclosure. As shown in FIG. 7, the pair of electrodes 130 is powered. For example, a negative voltage may be supplied to the electrode 130 on the left, and a positive voltage may be supplied to the electrode 130 on the right, so that there is a voltage difference between the pair of electrodes 130, and thus an electric field is generated. For ease of description, the electrode 130 on the left is referred to as a negative electrode plate 131, and the electrode 130 on the right is referred to as a positive electrode plate 132. The electric field between the positive electrode plate 132 and the negative electrode plate 131 acts on the charged particles 122 inside the liquid lens. The charged particles 122 inside the liquid lens include positively charged particles 1221 and negatively charged particles 1222. The positively charged particles 1221 will get closer to the negative electrode plate 131, and the negatively charged particles 1222 will get closer to the positive electrode plate 132. The positively charged particles 1221 and the negatively charged particles 1222 move towards the corresponding electrode 130 respectively, so that the transparent thin film will be stretched towards the respective sides where the electrodes 130 are located as the charged particles 122 move, and thus the liquid lens is deformed into an ellipsoid, the long axis of the ellipsoid being parallel to the arrangement plane.

When the intensity of the electric field between the positive electrode plate 132 and the negative electrode plate 131 is different, the attractive force of the electrodes 130 to the charged particles 122 in the liquid lens will be different. Therefore, the resulted deformation level of the liquid lens is different, and the curvature radius obtained is also different, so that the focal length of the lens unit 100 is varies accordingly.

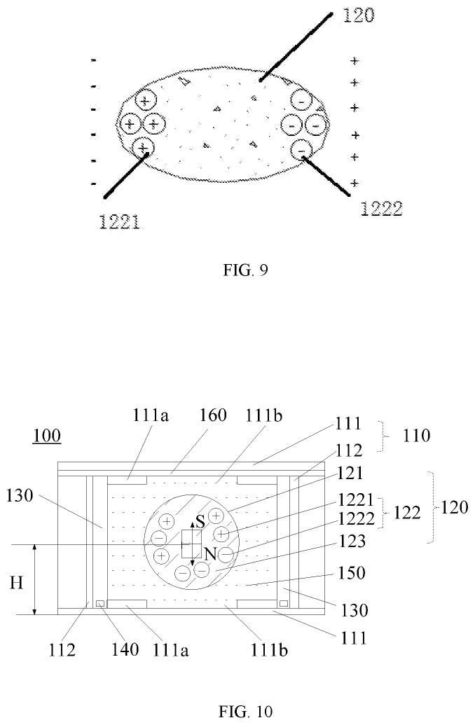

FIG. 8 is a schematic diagram showing the state of a liquid lens under a weak electric field according to an embodiment of the present disclosure. As shown in FIG. 8, when the intensity of the electric field is small, the distance between the positively charged particles 1221 and the negatively charged particles 1222 after moving towards the two ends is relatively short, so that the curvature radius of the liquid lens in the arrangement direction of the lens unit 100 is small, and thus the focal length of the lens unit 100 is also small. FIG. 9 is a schematic diagram of the state of a liquid lens under a strong electric field according to an embodiment of the present disclosure. As shown in FIG. 9, when the electric field intensity is large, the distance between the positively charged particles 1221 and the negatively charged particles 1222 after moving towards two ends is relatively long, so that the curvature radius of the liquid lens is large, and thus the focal length of the lens unit 100 is also large. Therefore, by adjusting the voltage difference between the pair of electrodes 130, the deformation degree of the corresponding liquid lens can be controlled, and thus the focal length of the lens unit 100 can be adjusted. As such, during the using process, according to the requirement of the pattern on the two-dimensional panel display, not only can the object distance be adjusted by the magnetic field generating member 160, the focal length of the lens unit 100 can also be adjusted, and thus a better stereoscopic display effect can be obtained.

Exemplarily, the electrode 130 may be a transparent electrode or a non-transparent electrode. When the electrode 130 is a transparent electrode, it may be made of ITO; when the electrode is a non-transparent electrode, it may be made of a metal material that is easy to form a film by sputtering, for example, Cu, Ag or the like.

In some embodiments, the electrode 130 may be made by first forming a film on the substrate 111 by sputtering, and then manufacturing the electrode 130 through a mask lithography. Exemplarily, the height of the electrode 130 may be less than 50 μm, and the electrode 130 may be superimposed to the required height through multiple sputtered film formation processes or through a single sputtered film formation process, which is not limited in the present disclosure.

The transparent thin film 121 may be a transparent organic insulating film. Exemplarily, the materials may be non-elastic transparent insulating materials such as polyimide films, polyester films or polyolefin films and the like, or elastic transparent insulating materials such as ethylene propylene rubber, ethylene-vinyl acetate, chlorohydrin rubber, butyl rubber and the like.

The charged particles may be electrophoretic particles with positive or negative charges, such as electronic ink. At present, the minimum particle size of the electronic ink ranges from 1 μm to 2 μm. As the diameter of the charged particle is very small, it is difficult to detect by human eyes. Therefore, the charged particles 122 inside the liquid lens may be transparent or non-transparent. The electrophoretic particles may be charged particles mainly synthesized by polymer materials such as polystyrene and polyethylene, or be charged particles mainly made of titanium dioxide and the like.

In some embodiments, the liquid lens may be manufactured separately and then placed inside the accommodating cavity. The method for manufacturing the liquid lens may be similar to that for manufacturing microcapsules or electrophoretic spheres of electronic paper. In the following, the manufacturing process of the liquid lens is described by taking the manufacture of microcapsules from TiO₂ particles as an example. First, the surface modification treatment is carried out on TiO₂ particles by using a toluene solvent dissolved with stearic acid. A one-step complex coacervation method is then performed by using Span 80 (sorbitan oleate) as the charge control agent, trichloroethylene (TCE) as the dispersant for preparing the base liquid, and gelatin as the wall material. Here, the complex coacervation method refers to such a process that two types of wall materials having opposite charges are used as embedding materials and dissolved in aqueous solution; after core materials are dispersed in aqueous solution, by changing the pH value, temperature or concentration of the aqueous solution in the system, the two wall materials interact with each other and form a complex which has a decreased solubility; and then with the aggregation and precipitation of the complex, the microcapsules can be formed.

The number of positively and negatively charged particles in the liquid lens may vary depending on the application situation: when the sizes of the charged particles are large, the number of particles may be reduced accordingly; when the sizes of the charged particles are small, the number of particles may be increased accordingly. In the embodiment of the present disclosure, the magnetic particles 124 are also located in the liquid lens, and the magnetic particles 124 are electrically neutral.

Exemplarily, the total volume of the charged particles in the liquid lens accounts for 0.1% to 5% of the volume of the liquid lens. The setting of this proportion of the charged particles 122 can ensure that the charged particles obtain sufficient electric field force to drive the liquid lens to deform, and it can also ensure that the charged particles 122 are accumulated at the edge of the liquid lens proximal to the electrodes 130, so as to reduce the charged particles in the middle of the liquid lens and reduce the interference of the charged particles 122 on light.

In a possible implementation, a transparent filling liquid 150 may be provided between the accommodating cavity 110 and the liquid lens to improve the stability of the liquid lens in the accommodating cavity 110. The refractive index of the transparent filling liquid 150 shall be smaller than that of the transparent insulating liquid 123, so as to ensure that the liquid lens can be used as a convex lens. Moreover, the liquid lens is suspended in the transparent filling liquid 150, which may lead to that the respective liquid lenses are basically located in the same plane, which is conducive to the accurate adjustment of the focal length.

Exemplarily, the transparent filling liquid 150 may include pure water or non-polar oil. Exemplarily, the non-polar oil may be silicone oil.

Exemplarily, the transparent insulating liquid 123 may be a non-polar liquid. For example, it may be a non-polar liquid with a refractive index ranging from 1 to 3, which is used to disperse the charged particles. For example, chemicals having similar densities as charged particles can generally be selected, such as non-polar alkanes, cycloalkanes, aromatic hydrocarbons, tetrachloroethylene, and tetrachloromethane, or mixtures thereof in different proportions that also have a similar density.

It should be noted that, in other embodiments, the transparent filling liquid 150 may not be filled between the accommodating cavity 110 and the liquid lens, rather, air or vacuum can be used as the light propagation medium as long as the liquid lens can be deformed in the accommodating cavity 110.

FIG. 10 is a schematic structural diagram of another lens device according to an embodiment of the present disclosure. As shown in FIG. 10, optionally, a light shielding block 111a may also be provided on the substrate 111. The center of the light shielding block 111a has a light-transmitting hole 111b. The center of the light-transmitting hole 111b corresponds to the position of the liquid lens, so as to reduce the light interference caused by the refraction and reflection of the transparent filling liquid 150. It should be noted that the lens unit in FIGS. 1 to 3 may also be provided with a light shielding block 111a on the substrate 111 in the same manner as that in FIG. 10.

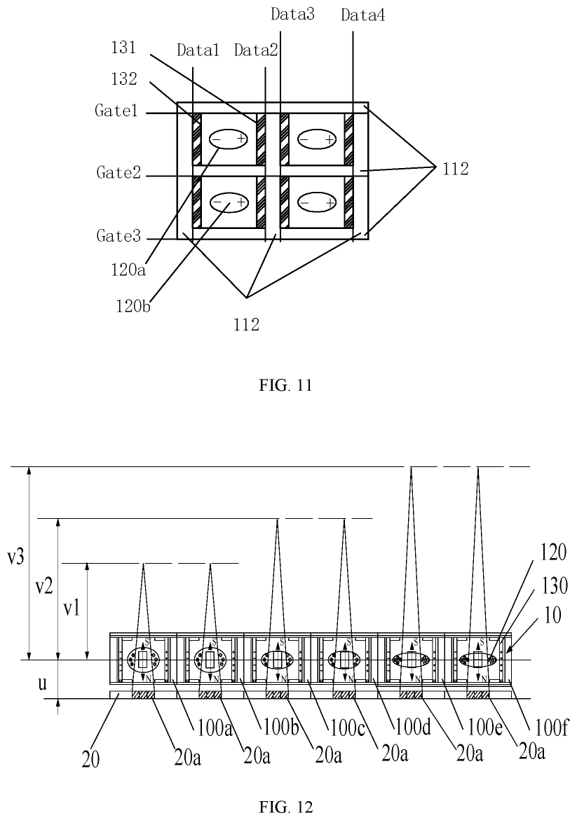

FIG. 11 is a partial schematic diagram of a control circuit according to an embodiment of the present disclosure. As shown in FIG. 11, the lens device 11 may further include a plurality of gate lines (such as Gate1, Gate2, and Gate3 in FIG. 10) and a plurality of data lines (such as Data1, Data2, Data3, and Data4 in FIG. 11). The gate lines and data lines intersect with each other to form a plurality of display areas, and each display area has a lens unit 100. Two adjacent data lines are respectively connected to a pair of electrodes 130 for providing voltage to the electrodes 130.

Each display area has at least one thin film transistor switch, the gate electrode of the thin film transistor switch is connected to the gate line, the source electrode is connected to the data line, and the drain electrode is connected to the corresponding data line. The gate line is used to receive an external control signal to control the on and off of the thin film transistor, so as to control the writing of the voltage in the data line. When the thin film transistors in a row of display areas are all turned on by one gate line, the voltage of the electrode 130 of each lens unit 100 in the row of display areas can be controlled through the voltage written by each data line.

Exemplarily, with reference to FIGS. 10 and 11, the orthographic projection of the control circuit composed of the gate line, the data line, and the thin film transistor onto the substrate 111 may be located in the orthographic projection of the insulating barrier 112 of the lens unit 100 onto the substrate 111, so as to avoid the blockage of the light.

For the structure of the substrate 111 on which the gate line, the data line and the thin film transistor have been formed, reference can be made to the structure of an array substrate in the display substrate. For example, the array substrate may include: a base substrate, and a gate electrode metal layer, an insulating layer, a source and drain electrodes metal layer and a planarizing layer which are sequentially laminated on the base substrate, which will not be described in detail herein.

Optionally, the control circuit for providing current to the spiral coil 160 and the control circuit for providing voltage to the electrode 130 may be disposed on two substrates respectively to avoid the control signals from interfering with each other.

With reference to FIG. 12, the embodiment of the present disclosure further provides a display device which includes a display panel 20 and the aforementioned lens device 10. The lens device 10 is located on the light-exiting side of the display panel 20.

Optionally, the display panel 20 includes a plurality of pixels 20a, and one lens unit 100 is opposed to one pixel 20a in a direction perpendicular to the first substrate 111. For example, as shown in the figure, each pixel 20a of the display panel includes three sub-pixels, i.e., the red, green, and blue sub-pixels respectively, and the three sub-pixels correspond to one lens unit 100.

Optionally, in the embodiment of the present disclosure, the display panel 20 may be an organic light-emitting diode (OLED) display panel, or a liquid crystal display (LCD) display panel, or the like.

The principle and process of adjusting the focal length of the lens unit in the embodiment of the present disclosure are briefly described below.

According to the imaging rule of the convex lens, the aforementioned formulas (1) and (2) hold.

In addition, another formula also holds:

$$f = \frac{{n}_{0 r}}{2 ( n - {n}_{0} )} . \qquad ( 3 )$$

In formula (3), r represents the curvature radius of the lens, that is, the curvature radius of the liquid lens in the embodiment of the present disclosure; n represents the refractive index of the lens, that is, the refractive index of the transparent insulating liquid 123 in the embodiment of the present embodiment; and no is the refractive index of the medium, that is, the refractive index of the medium filled between the lens 120 and the side wall of the accommodating cavity 110 in the embodiment of the present disclosure, for example, the refractive index of the liquid 150 or air.

As shown in FIG. 12, under the condition that the distance u between the center of the lens and the display panel is constant, when the curvature radius r of the liquid lenses in the lens units 100a and 100b is small, the focal length f of the lenses of the lens units 100a and 100b is relatively small, then the image distance v1 is also relatively small; when the curvature radius of the liquid lenses in the lens units 100e and 100f is large, the focal length f of the lenses of the lens units 100e and 100f is relatively large, then the image distance v3 is also relatively large. That is, the image distance of the pixel 20 can also be adjusted through the curvature radius of the liquid lens.

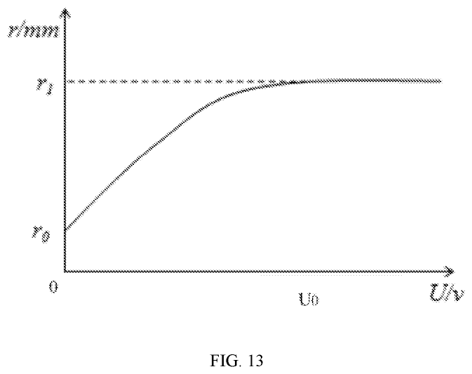

FIG. 13 is a diagram showing the relationship between the curvature radius of the lens and the voltage of the electric field in an embodiment. As shown in FIG. 13, the curvature radius r of the liquid lens has a one-to-one correspondence with the voltage U of the electric field, that is,

r=f(U) (4).

By adjusting the voltage to change within the range 0<U<U0, the corresponding curvature radius of the liquid lens changes within the range r0<r<r1, the focal length of the lens changes within the range f0<f<f1, and the corresponding image distance changes within the range v0<v<v1. Here, r0 is the original curvature radius, and r1 is the limit curvature radius of the liquid lens, that is, the limitation of curvature radius that can be reached through the deformation of the liquid lens. That is, there is a mapping relationship between the voltage U of the electrode and the image distance v:

$$v = f = \frac{{n}_{0} f ( U )}{2 ( n - {n}_{0} )} . \qquad ( 5 )$$

During implementation, the mapping relationship can be obtained by experiment and stored in a controller of the display device, such that it can be used by the controller when the voltage U of the electrode is adjusted.

When the lens unit has both the magnetic field generating member 160 and the electrode 130, in this way, the lens unit may adjust both the focal length and the object distance and realize flexible adjustment of the imaging height through the coordinated adjustment of the focal length and the object distance. Under the circumstance that the change in the object distance is within a limited range, through the adjustment of the focal length, the adjustment range of imaging height can be further widened, which may better meet the demand of stereoscopic display.

The embodiment of the present disclosure further provides a control method of a lens device, which is implemented based on the aforementioned lens device. The method includes: providing a driving current to the magnetic field generating member of a target lens unit, so that the lens in the target lens unit moves in the direction perpendicular to the arrangement plane, and the target lens unit is any lens unit in the lens device.

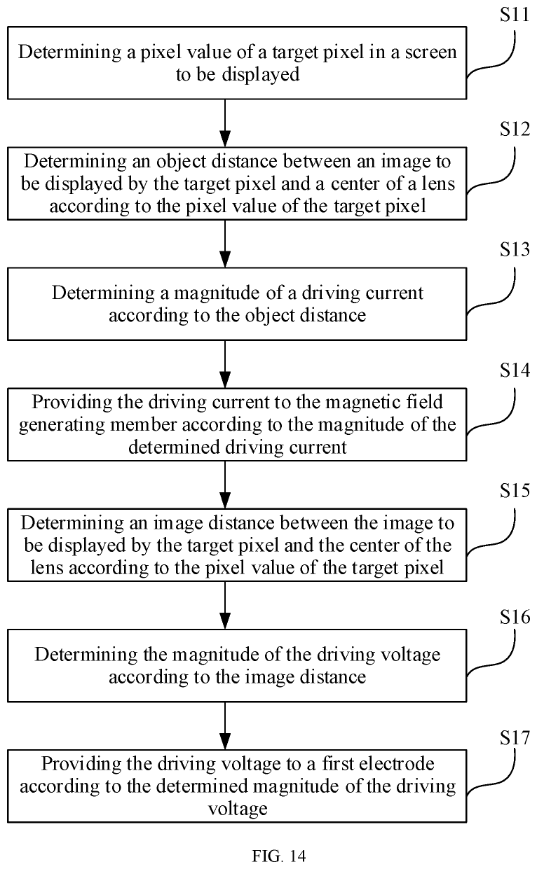

FIG. 14 is a flow diagram showing a control method of a lens device according to an exemplary embodiment. With reference to FIG. 14, the method includes:

In step S11, the pixel value of a target pixel in the screen to be displayed is determined.

The target pixel here may be any pixel in the screen to be displayed.

In step S12, the object distance between the image to be displayed by the target pixel and the center of the lens is determined according to the pixel value of the target pixel.

Here, because the image is a 3-dimensional image, the pixel value of each image should also include 3-dimensional spatial information in addition to the gray scale. Based on the 3-dimensional spatial information, the imaging height of the image to be displayed by the target pixel can be determined. The object distance u between the display panel and the center of the lens can be determined according to the target imaging height. For example, the difference between the target imaging height and the default focal length is determined as the object distance u. Exemplarily, the default focal length may be the focal length when the liquid lens is not deformed, or the focal length of the solid lens.

In step S13, the magnitude of the driving current is determined according to the object distance.

In step S14, the driving current is provided to the magnetic field generating member according to the magnitude of the determined driving current.

According to the above method, the driving current corresponding to each pixel in the screen to be displayed can be determined.

When the driving current is provided to each magnetic field generating member, if the coil control lines connected to each magnetic field generating member are independent of each other, it is only necessary to input the driving current to the corresponding coil control line; if the magnetic field generating member in a row of lens units is connected to one first coil control line, and the magnetic field generating member in a column of lens units is connected to one second coil control line, it is necessary to select which magnetic field generating member to be provided with the driving current through a control switch.

By adjusting the magnitude of the driving current, the intensity of the magnetic field generated by the magnetic field generating member can be controlled, and thus the object distance between the center of the corresponding lens and the display panel can be controlled, so that the imaging height can be adjusted to obtain a better stereoscopic display effect.

Optionally, in addition to presenting a 3-dimensional image by adjusting the object distance, for the lens device shown in FIGS. 5 to 11, the 3-dimensional display effect can be further adjusted by adjusting the focal length of the lens. Therefore, the method may further include:

In step S15, the image distance between the image to be displayed by the target pixel and the center of the lens is determined according to the pixel value of the target pixel.

As mentioned above, the pixel value of each image should also include 3-dimensional spatial information in addition to the gray scale. Based on the 3-dimensional spatial information, the imaging height of the image to be displayed by the target pixel can be determined. The image distance v between the image to be displayed by the target pixel and the center of the lens can be determined according to the target imaging height and the object distance u determined in the above steps.

Exemplarily, in the case where the object distance u is determined first, the image distance v can be the difference between the target imaging height and the determined object distance u.

In step S16, the magnitude of the driving voltage is determined according to the image distance.

According to the aforementioned formula (5) and related descriptions, the mapping relationship between the voltage U of the electrode and the image distance v has been determined and stored in advance. In this step, it is only necessary to call the corresponding relationship between the voltage and the image distance as stored, and search the voltage corresponding to the image distance v through the corresponding relationship.

In step S17, the driving voltage is provided to the electrode according to the determined magnitude of the driving voltage.

According to the above method, the driving voltage corresponding to each pixel in the screen to be displayed can be determined. When the driving voltage is written, it may be written row by row, and the process may include the following step:

the gate-on voltage is written into the control gate lines row by row to turn on the control switch in the row.

Exemplarily, with reference to FIG. 11, a scanning signal is supplied into the gate line (that is, a gate-on voltage is written) to turn on the control switch, so that the data line Data1 and the positive electrode plate 132 are turned on, and the data line Data2 and the negative electrode plate 131 are also turned on.

Exemplarily, the control switch may be a thin film transistor (TFT), the source and drain electrodes of the TFT are connected respectively to the data line and the electrode, and the gate electrode of the TFT is connected to the gate line. When the gate line is supplied with the scanning signal, the TFT is turned on, so that the data line and the electrode are turned on.

When a row of control switches is turned on, each data line is controlled to output a driving voltage to the electrode of each lens unit, based on the determined driving voltage of each lens unit in the row.

Here, a high potential and a low potential are input respectively into two data lines corresponding to the same lens unit, so as to generate a driving voltage and thereby generate an electric field between the electrodes. Exemplarily, with reference to FIG. 11, two adjacent data lines Data1 and Data 2 are respectively connected to the positive electrode plate 132 and the negative electrode plate 131 of the electrode through the control switches. The data line Data1 is input with a high potential to supply power to the positive electrode plate 132 of the electrode, and the data line Data2 is input with a low potential to supply power to the negative electrode plate 131 of the electrode. An electric field is generated between the positive electrode plate 132 and the negative electrode plate 131 and acts on the liquid lens, so that the shape of the liquid lens is changed.

As mentioned above, during the implementation, the gate lines may be scanned row by row. When the gate line Gate 1 is powered, the TFT connected to the gate line Gate 1 is turned on, and the data lines Data 1 and Data 2 are input with high and low potentials respectively, which supplies power to the positive electrode plate 132 and the negative electrode plate 131, so as to realize the control on the shape of the liquid lens 120a and thereby control the focal length of the liquid lens 120a; when the gate line Gate 2 is powered, the TFT switch connected to the gate line Gate 2 is turned on, and the data lines Data 1 and Data 2 are input with high and low potentials respectively to realize the control on the liquid lens 120b.

It should be noted that in the embodiment of the present disclosure, the object distance may be adjusted first, and after the position (i.e., the height) of the lens 120 is stable, the focal length may be then adjusted until the deformation of the lens 120 is completed. Alternatively, the focal length may be adjusted first, and after the shape of the lens 120 is stabilized, the object distance may then be adjusted until the position of the lens 120 is stabilized.

In addition, in this embodiment, the object distance u is first determined according to the imaging height, and then the image distance v is determined according to the imaging height and the object distance u. In other embodiments, the image distance v may be determined first according to the imaging height, and then the object distance u can be determined according to the imaging height and image distance v.

When the lens unit has both the magnetic field generating member 160 and the electrode 130, the lens unit can adjust both the focal length and the object distance in the manner mentioned above, to realize flexible adjustment of the imaging height through the coordinated adjustment of the focal length and the object distance. Under the circumstance that the change in the focal length of lens is within a limited range, the adjustment range of imaging height can be widened, which better meets the demand of stereoscopic display.

The above descriptions are merely optional embodiments of the present disclosure, and are not intended to limit the present disclosure. Any modifications, equivalent substitutions or improvements that are made within the concept and principle of the present disclosure should all be included in the protection scope of the present disclosure.

1. A lens device, comprising a plurality of lens units arranged in an array, wherein the lens unit comprises an accommodating cavity, a lens, a magnetic body, and a magnetic field generating member; the lens and the magnetic body are located inside the accommodating cavity, the magnetic field generating member is configured to provide a magnetic field, and the magnetic body is configured to move the lens in a direction perpendicular to an arrangement plane of the plurality of lens units under an action of the magnetic field provided by the magnetic field generating member.

2. The lens device according to claim 1, wherein the magnetic field generating member is a spiral coil, an axis of the spiral coil being perpendicular to the arrangement plane.

3. The lens device according to claim 2, wherein the spiral coil is a planar spiral coil wound by a transparent wire.

4. The lens device according to claim 1, wherein the magnetic body is located inside the lens.

5. The lens device according to claim 4, wherein the magnetic body comprises magnetic particles comprising magnetic powder and a transparent bonding agent.

6. The lens device according to claim 1, wherein the magnetic body is located between the lens and a side wall of the accommodating cavity.

7. The lens device according to claim 6, wherein the magnetic body is a transparent magnetic sheet-shaped structure parallel to the arrangement plane.

8. The lens device according to claim 1, wherein the lens is at least one of the following:
a liquid lens, comprising a transparent thin film and a transparent liquid inside the transparent thin film; or
a solid lens.

9. The lens device according to claim 1, wherein the lens unit further comprises two opposed substrates and an insulating barrier connected between the two substrates, the substrates and the insulating barrier define the accommodating cavity, and the magnetic field generating member is located on at least one of the substrates.

10. The lens device according to claim 9, wherein a side wall of the insulating barrier is provided with a magnetic field shielding layer.

11. The lens device according to claim 9, wherein the lens unit further comprises a pair of electrodes located on two sides of a corresponding lens in a direction parallel to the arrangement plane; the lens is a liquid lens comprising a transparent thin film, and charged particles and a transparent insulating liquid which are located in the transparent thin film; and the charged particles are configured to move under an action of an electric field provided by the pair of electrodes, so as to deform the liquid lens to which they belong.

12. The lens device according to claim 11, wherein a total volume of the charged particles in the liquid lens accounts for 0.1% to 5% of a volume of the liquid lens.

13. The lens device according to claim 1, further comprising two opposed substrates and an insulating barrier connected between the two substrates, wherein the substrates and the insulating barrier define a plurality of the accommodating cavities, and the magnetic field generating member is a planar spiral coil located on at least one of the substrates;
the lens unit further comprises a pair of electrodes located on a side wall of a corresponding accommodating cavity, and the pair of electrodes are located on two sides of the corresponding lens in a direction parallel to the arrangement plane; and
the lens is a liquid lens comprising a transparent thin film, and charged particles, magnetic particles and a transparent insulating liquid which are located inside the transparent thin film; the charged particles are configured to move under an action of an electric field provided by the pair of electrodes, so as to deform the liquid lens to which they belong.

14. The lens device according to claim 13, further comprising a control circuit of the spiral coil and a control circuit of the electrode, wherein the planar spiral coil and the control circuit of the spiral coil are located on one substrate, and the control circuit of the electrode is located on another substrate.

15. A display device comprising a display panel and a lens device, wherein the lens device is located on a light-exiting side of the display panel and comprises a plurality of lens units arranged in an array; each of the lens units comprises an accommodating cavity, a lens, a magnetic body, and a magnetic field generating member; the lens and the magnetic body are located inside the accommodating cavity; the magnetic field generating member is configured to provide a magnetic field; and the magnetic body is configured to move the lens in a direction perpendicular to an arrangement plane of the plurality of lens units under an action of the magnetic field provided by the magnetic field generating member.

16. The display device according to claim 15, wherein the display panel comprises a plurality of pixels, and one of the lens units is opposed to one of the pixels in a direction perpendicular to the light-exiting side of the display panel.

17. The display device according to claim 16, wherein the lens device further comprises two opposed substrates and an insulating barrier connected between the two substrates, the substrates and the insulating barrier define a plurality of accommodating cavities, and the magnetic field generating member is a planar spiral coil located on at least one of the substrates;
the lens unit further comprises a pair of electrodes located on a side wall of a corresponding accommodating cavity, and the pair of electrodes are located on two sides of the corresponding lens in a direction parallel to the arrangement plane; and
the lens is a liquid lens comprising a transparent thin film, and charged particles, and magnetic particles and a transparent insulating liquid which are located inside the transparent thin film, wherein the charged particles are configured to move under an action of an electric field provided by the pair of the electrodes, so as to deform the liquid lens to which they belong.

18. The display device according to claim 17, wherein the lens device further comprises a control circuit of the spiral coil and a control circuit of the electrode, the planar spiral coil and the control circuit of the spiral coil are located on one substrate, and the control circuit of the electrode is located on another substrate.

19. A control method of a lens device, wherein the lens device comprises a plurality of lens units arranged in an array; each of the lens units comprises an accommodating cavity, a lens, a magnetic body and a magnetic field generating member; the lens and the magnetic body are located inside the accommodating cavity, the magnetic field generating member is configured to provide a magnetic field, and the magnetic body is configured to move the lens in a direction perpendicular to an arrangement plane of the plurality of lens units under an action of the magnetic field provided by the magnetic field generating member, the method comprises:
providing a driving current to the magnetic field generating member of a target lens unit, so that the lens of the target lens unit moves in the direction perpendicular to the arrangement plane, and the target lens unit is any lens unit in the lens device.

20. The method according to claim 19, wherein the lens unit further comprises a pair of electrodes located on two sides of a corresponding lens in a direction parallel to the arrangement plane of the plurality of lens units; the lens is a liquid lens comprising a transparent thin film, and charged particles and a transparent insulating liquid which are located in the transparent thin film, the method further comprises:
providing a driving voltage to the pair of the electrodes of the target lens unit, so as to move the charged particles in the liquid lens of the target lens unit to deform the liquid lens of the target lens unit.
